(19) United States
(12) Patent Application Publication
(10) Pub. No.: US 2003/0200089 A1
(43) Pub. Date: Oct. 23, 2003

(54) Speech recognition apparatus and method, and program

(75) Inventors: Kenichiro Nakagawa, Tokyo (JP); Hiroki Yamamoto, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/414,228

(22) Filed: Apr. 16, 2003

(30) Foreign Application Priority Data
Apr. 18, 2002 (JP) 2002-116307

(51) Int. Cl. G10L 15/04; G10L 15/00

(52) U.S. Cl. 704/251

(57) ABSTRACT

Speech data is input from a speech capture unit. External data including vocabulary information is read from an external data acquisition unit. A speech recognition unit makes speech recognition of the speech data using the vocabulary information in the external data and recognition vocabulary information in a recognition vocabulary database, and outputs its speech recognition result.

### FIELD OF THE INVENTION

The present invention relates to a speech recognition apparatus and method for recognizing input speech, and a program.

### BACKGROUND OF THE INVENTION

In recent years, compact portable terminals have prevailed, and users can make sophisticated information process activities anywhere they want. Such portable terminal is used by an end user as a scheduler, Internet browser, and e-mail tool, and is also used in merchandise management, meter read service, financial sales, and the like for business purposes. Some of such compact portable terminals comprise compact printers and scanners, and can read/write high-density data called a two-dimensional (2D) barcode via a sheet surface or the like.

A compact portable terminal is unsuited to complex input jobs since it is difficult to attach a large number of keys like a keyboard to it due to its compactness. By contrast, input using speech requires only a space for a microphone, and can greatly contribute to a size reduction of a device. A recent compact portable terminal has improved performance, which is high enough to cope with speaker-independent speech recognition process, which may require a large calculation volume. Hence, the speech recognition process in the compact portable terminal is expected to be an important factor in the future.

However, recognition errors are inherent to speech recognition, and the process normally becomes more complicated with increasing size of vocabulary to be recognized (recognition vocabulary). For this reason, it is demanded to reduce recognition errors by decreasing the size of recognition vocabulary used in a single recognition process by switching a recognition vocabulary of contents that the user may utter.

A speech recognition apparatus which can switch recognition words by reading external data such as a 2D barcode has been proposed. With this technique, an information terminal pre-stores all words that the user is expected to utter as a recognition vocabulary, and activates some items of the recognition vocabulary depending on the contents of external data to implement speech recognition. For example, in Japanese Patent Laid-Open No. 09-006798, speech recognition is made by activating recognition words of a field corresponding to external data (color code).

With this method, since external data need not include any vocabulary information, the data size to be included in external data can be suppressed. Since the information terminal stores the recognition vocabulary, a new word (not included in the recognition vocabulary of the terminal) cannot be recognized.

### SUMMARY OF THE INVENTION

The present invention has been made in consideration of the aforementioned problems, and has as its object to provide a speech recognition apparatus and method, which can easily expand the size of recognition vocabulary, and can improve operability, and a program.

According to the present invention, the foregoing object is obtained by providing a speech recognition apparatus for recognizing input speech, comprising:

storage means for storing recognition vocabulary information for speech recognition;

input means for inputting speech data;

read means for reading external data including vocabulary information;

speech recognition means for making speech recognition of the speech data using the vocabulary information in the read external data, and the recognition vocabulary information; and

output means for outputting a speech recognition result of the speech recognition means.

In a preferred embodiment, the vocabulary information contains phonetic information of a word.

In a preferred embodiment, the external data has a format that allows printing on a recording medium.

In a preferred embodiment, the external data is a two-dimensional barcode.

In a preferred embodiment, the external data is an image which contains the vocabulary information generated by a digital watermarking technique.

In a preferred embodiment, the apparatus further comprises:

management means for managing the recognition vocabulary information; and

input means for inputting a processing instruction to the management means.

In a preferred embodiment, the management means deletes at least some items of the recognition vocabulary information on the basis of an instruction input from the input means.

According to the present invention, the foregoing object is obtained by providing a speech recognition method for recognizing input speech, comprising:

an input step of inputting speech data;

a read step of reading external data including vocabulary information;

a speech recognition step of making speech recognition of the speech data using the vocabulary information in the read external data, and recognition vocabulary information stored in a recognition vocabulary database; and

an output step of outputting a speech recognition result of the speech recognition step.

According to the present invention, the foregoing object is obtained by providing a program for making a computer implement speech recognition for recognizing input speech, comprising:

a program code of an input step of inputting speech data;

a program code of a read step of reading external data including vocabulary information;

a program code of a speech recognition step of making speech recognition of the speech data using the vocabulary information in the read external data, and recognition vocabulary information stored in a recognition vocabulary database; and

a program code of an output step of outputting a speech recognition result of the speech recognition step.

Further objects, features and advantages of the present invention will become apparent from the following detailed description of embodiments of the present invention with reference to the accompanying drawings.

### BRIEF DESCRIPTION OF THE DRAWINGS

FIG. 1 is a functional block diagram of a speech recognition apparatus according to the first embodiment of the present invention;

FIG. 2 shows an example of external data according to the first embodiment of the present invention;

FIG. 3 is a flow chart showing the process to be executed by the speech recognition apparatus according to the first embodiment of the present invention;

FIG. 4 is a flow chart showing details of an external data acquisition process according to the first embodiment of the present invention;

FIG. 5 is a flow chart showing details of a speech recognition process according to the first embodiment of the present invention;

FIG. 6 shows an example of the configuration of a recognition vocabulary database according to the first embodiment of the present invention;

FIG. 7 is a view showing the arrangement of a speech recognition apparatus according to the second embodiment of the present invention;

FIG. 8 is a view showing the arrangement of a speech recognition apparatus according to the third embodiment of the present invention; and

FIG. 9 is a view showing the arrangement of a speech recognition apparatus according to the fourth embodiment of the present invention.

### DETAILED DESCRIPTION OF THE PREFERRED EMBODIMENTS

Preferred embodiments of the present invention will be described in detail hereinafter with reference to the accompanying drawings.

<First Embodiment>

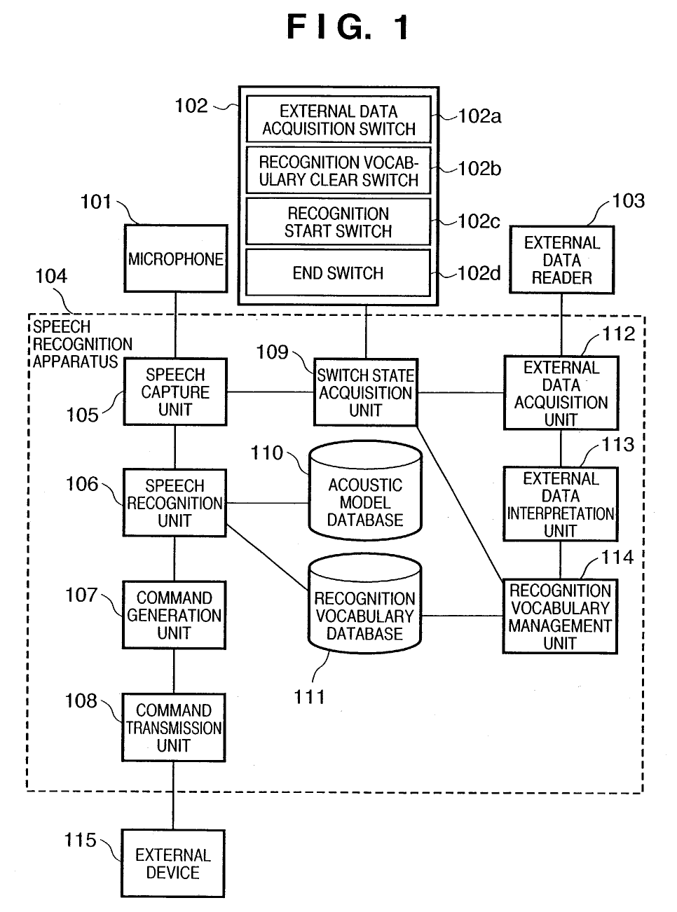

FIG. 1 is a functional block diagram of a speech recognition apparatus according to the first embodiment of the present invention.

A speech recognition apparatus 104 captures user's speech data from a speech input device such as a microphone 101 or the like, converts that speech data into a command by a speech recognition process, and sends that command to an external device 115.

A microphone 101, switch 102, external data reader 103, and external device 115 are externally connected to the speech recognition apparatus 104. The microphone 101, switch 102, external data reader 103, and external device 115 are respectively connected to a speech capture unit 105, switch state acquisition unit 109, external data acquisition unit 112, and command transmission unit 108 in the speech recognition apparatus 104.

The switch 102 may be either a simple push button or a touch panel. The switch 102 has at least the following four switches. That is, the switch 102 includes an external data acquisition switch 102a used to enable the external data reader 103 to add vocabulary information, a recognition vocabulary clear switch 102b used to clear the contents of a recognition vocabulary database 111 in the speech recognition apparatus 104, a recognition start switch 102c used to start speech capture to execute a speech recognition process, and an end switch 102d used to instruct to end the process.

Upon depression of the external data acquisition switch 102a, the switch state acquisition unit 109 enables the external data acquisition unit 112. The external data acquisition unit 112 enables the external data reader 103 to read external data.

Note that the external data reader 103 is not particularly limited as long as it can read external data which is formed in a format that can be printed on recording media such as cloth, a plastic film, a metal plate, and the like as well as paper. For example, a scanner, barcode reader, 2D barcode reader, and the like may be used.

The first embodiment will exemplify a 2D barcode reader that reads external data formed of a 2D barcode as the external data reader 103.

The read external data (2D barcode) is sent to an external data interpretation unit 113, which interprets the contents of that data. As for interpretation of external data (2D barcode), a state-of-the-art technique is used, and a detailed description thereof will be omitted. Assume that vocabulary information is registered in this 2D barcode. The read vocabulary information is sent to a recognition vocabulary management unit 114. In this case, a recognition vocabulary database 111 which manages recognition vocabulary data including notation information and phonetic information is accessed to add the read new vocabulary information as recognition vocabulary data of speech recognition. Since the recognition vocabulary data managed by the recognition vocabulary database 111 are used in speech recognition, addition of recognition vocabulary data can implement a function equivalent to addition of a word that the user can utter.

Upon depression of the recognition vocabulary clear switch 102b, the switch state acquisition unit 109 enables the recognition vocabulary management unit 114. The recognition vocabulary management unit 114 clears the recognition vocabulary database 111. This process may clear all recognition words registered in the recognition database 111, or may erase recognition vocabulary data other than basic recognition vocabulary data such as “yes”, “no”, “zero” to “nine”, and the like.

Upon depression of the recognition start switch 102c, the switch state acquisition unit 109 enables the speech capture unit 105. The speech capture unit 105 starts speech capture via the microphone 101. The captured speech data is sent to the speech recognition unit 106, and undergoes a speech recognition process using acoustic model data in an acoustic model database 110 and recognition vocabulary data in the recognition vocabulary database 111. The speech recognition process in this case uses a state-of-the-art speech recognition technique, and a detailed description thereof will be omitted.

The speech recognition result is sent to a command generation unit 107, which converts the speech recognition result into a corresponding command. This command is sent to the command transmission unit 108, which transmits the command to the external device 115.

Note that the speech recognition apparatus 104 comprises standard building components (e.g., a CPU, RAM, ROM, hard disk, external storage device, network interface, display, keyboard, mouse, and the like) equipped in a general-purpose computer.

The aforementioned building components may be implemented by executing a program stored in the internal ROM of the speech recognition apparatus 104 or the external storage device by the CPU or may be implemented by dedicated hardware.

Furthermore, the external device 115 may include, e.g., various devices such as a display device, personal computer, scanner, printer, digital camera, facsimile, copying machine, and the like, which can be connected to the speech recognition apparatus 104 directly or via a network, and may also include an external program, which runs on a terminal.

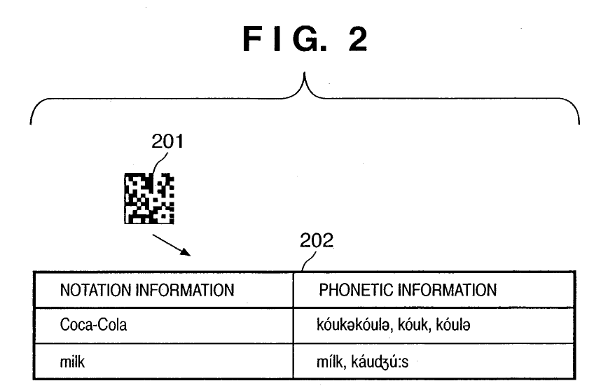

An example of external data of the first embodiment will be described below using FIG. 2.

FIG. 2 shows an example of external data according to the first embodiment of the present invention.

In this example, assume that one table 202 is expressed as vocabulary information in external data 201 formed by one 2D barcode. This table 202 stores some pieces of notation information corresponding to speech data which assume speech that the user may utter, and one or more pieces of phonetic information corresponding to those pieces of notation information.

In the speech recognition process, speech data that the user has uttered is compared with all pieces of phonetic information in the recognition vocabulary data, and notation information which has phonetic information, which is determined to be closest to that of the speech data, is output as a recognition result. Especially, the table 202 manages phonetic information of all nicknames (e.g., “kóuk”, “kóul [symbol] ”, and the like for “Coca-Cola” “kóuk [symbol] kôul [symbol] ”) which may be uttered in correspondence with each notation information. In this manner, the number of variations of recognition words which can be used to recognize speech data that the user has uttered can be increased, thus improving user's convenience.

In the first embodiment, the external data 201 is expressed by a 2D barcode. Alternatively, any other code systems such as a normal barcode and the like may be used as long as they can express vocabulary information.

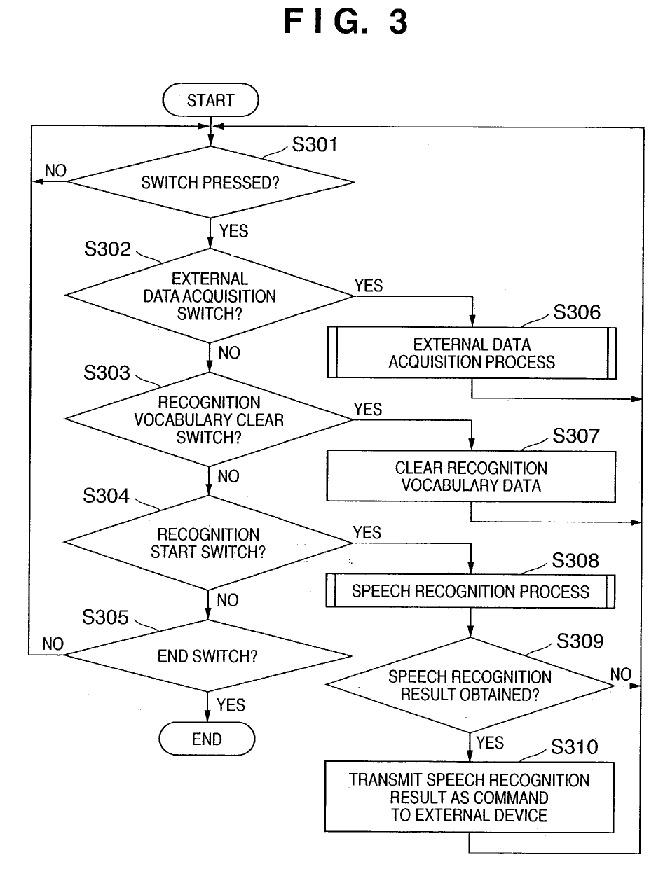

The process to be executed by the speech recognition apparatus of the first embodiment will be described below using FIG. 3.

When the speech recognition apparatus 104 of this embodiment starts, the switch state acquisition unit 109 checks if the user has pressed one of the switches (step S301). If the user has not pressed any switch (NO in step S301), the control waits until he or she presses an arbitrary switch. If the user has pressed one of the switches (YES in step S301), the flow advances to step S302.

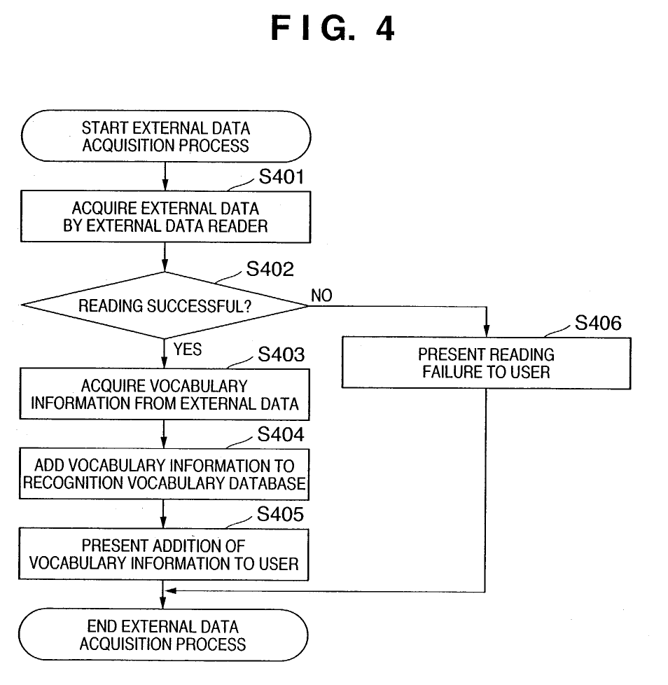

The switch state acquisition unit 109 checks if the type of pressed switch is the external data acquisition switch 102a (step S302). If the pressed switch is the external data acquisition switch 102a (YES in step S302), the flow advances to step S306, and the switch state acquisition unit 109 enables the external data acquisition unit 112 to execute an external data acquisition process. In this external data acquisition process, external data which contains vocabulary information is externally read using the external data reader 103, and the vocabulary information in the read external data is added to the recognition vocabulary database 111. Details of this process will be described later using FIG. 4.

On the other hand, if the type of pressed switch is not the external data acquisition switch 102a (NO in step S302), the switch state acquisition unit 109 checks if the type of pressed switch is the recognition vocabulary clear switch 102b (step S303). If the type of pressed switch is the recognition vocabulary clear switch 102b (YES in step S303), the flow advances to step S307, and the switch state acquisition unit 109 enables the recognition vocabulary management unit 114 to clear recognition vocabulary data in the recognition vocabulary database 111. At this time, all recognition vocabulary data may be cleared, or some specific recognition vocabulary data may be left without being cleared.

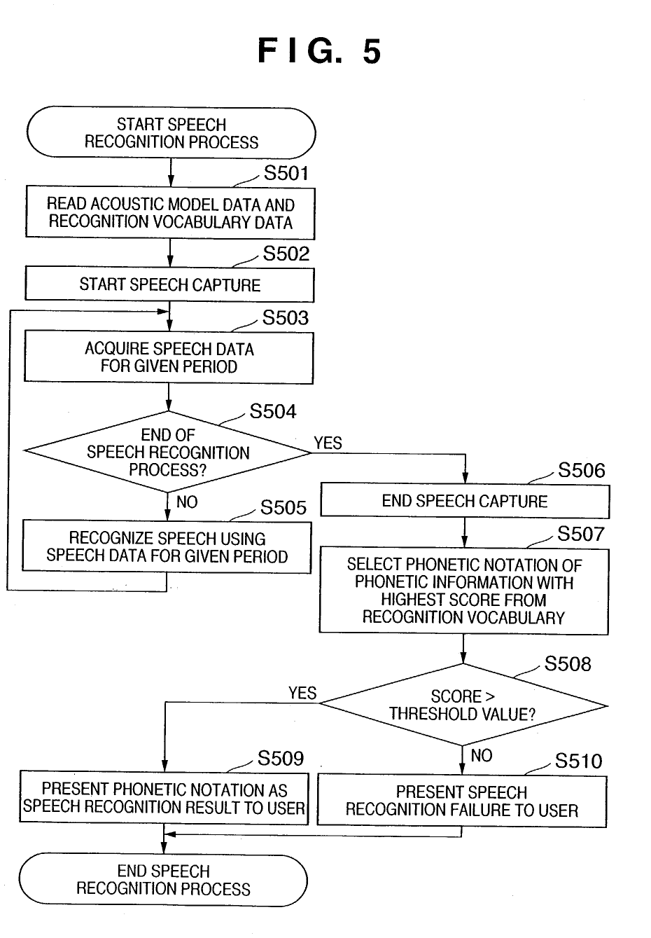

On the other hand, if the type of pressed switch is not the recognition vocabulary clear switch 102b (NO in step S303), the switch state acquisition unit 109 checks if the type of pressed switch is the recognition start switch 102c (step S304). If the type of pressed switch is the recognition start switch 102c (YES in step S304), the flow advances to step S308, and the switch state acquisition unit 109 enables the speech capture unit 105 to capture speech data via the microphone 101. Subsequently, the speech recognition unit 106 executes a speech recognition process of the captured speech data. This speech recognition process uses the one as a state-of-the-art technique. More specifically, this process selects a most suited word from the recognition vocabulary (recognition grammar) based on user's utterance in consideration of acoustical and linguistic limitations. Details of this process will be explained later using FIG. 5.

Upon completion of the speech recognition process, the command generation unit 107 checks the presence/absence of the speech recognition result (step S309). If speech recognition has failed, and no speech recognition result is obtained (NO in step S309), the flow returns to step S301. On the other hand, if the speech recognition result is obtained (YES in step S309), the flow advances to step S310, and the command generation unit 107 converts that speech recognition result into a command and transmits it to the external device 115 via the command transmission unit 108.

On the other hand, if the type of pressed switch is not the recognition start switch 102c (NO in step S304), the switch state acquisition unit 109 checks if the type of pressed switch is the end switch 102d (step S305). If the type of pressed switch is not the end switch 102d (NO in step S305), the flow returns to step S301. On the other hand, if type of pressed switch is the end switch 102d (YES in step S305), this process ends.

Details of the external data acquisition process in step S306 will be described below using FIG. 4.

FIG. 4 is a flow chart showing details of the external data acquisition process according to the first embodiment of the present invention.

In this process, vocabulary information in external data is added to the recognition vocabulary database 111 using the external data acquisition unit 103.

When this process is launched, the external data acquisition unit 112 enables the external data reader 103 to acquire external data (step S401).

The read external data is evaluated to determine whether or not the read operation of external data has succeeded (step S402). If the read operation has failed (NO in step S402), the flow advances to step S406 to notify the user of that failure, thus ending the process. In this case, notification may be made by displaying a read failure message on a display device attached to the speech recognition apparatus 104 or by generating an error beep tone.

On the other hand, if the read operation has succeeded (YES in step S402), the flow advances to step S403, and the external data interpretation unit 113 acquires vocabulary information in the external data. After that, the recognition vocabulary management unit 114 adds all recognition vocabulary data of the acquired vocabulary information to the recognition vocabulary database 111 (step S404).

Upon completion of addition, the user is notified that vocabulary information in the external data is normally added to the recognition vocabulary database 111 (step S405), thus ending this process. At this time, notification may be made by displaying a successful addition message on a display device attached to the speech recognition apparatus 104 or by generating a beep tone different from that for an error.

Details of the speech recognition process in step S308 will be described below using FIG. 5.

FIG. 5 is a flow chart showing details of the speech recognition process according to the first embodiment of the present invention.

When this process starts, the speech recognition unit 106 reads acoustic model data from the acoustic model database 110, and recognition vocabulary data from the recognition vocabulary database 111 (step S501). The speech recognition unit 106 then enables the speech capture unit 105 to start speech capture via the microphone 101 (step S502).

The speech recognition unit 106 acquires speech data for a given period (e.g., about 1/100 sec) from the captured speech data (step S503). The speech recognition unit 106 checks if the speech recognition process is finished with the captured speech data for the given period (step S504). In general, the speech recognition process is finished when it is determined user's utterance is complete. If the speech recognition process is not finished (if it is determined that user's utterance continues) (NO in step S504), the flow advances to step S505 to execute a speech recognition process of speech data for the next given period. Upon completion of the speech recognition process of speech data of that given period, the flow returns to step S503.

If the speech recognition process is finished (if it is determined that user's utterance is complete) (YES in step S504), speech capture via the microphone 101 ends (step S506). The speech recognition unit 106 selects a speech recognition candidate (phonetic notation of phonetic information) with the highest score (likeliness) of recognition words corresponding to the speech recognition result (step S507). The speech recognition unit 106 compares the selected score with a threshold value to see if the score is larger than the threshold value (step S508). If the score is larger than the threshold value (YES in step S508), the flow advances to step S509 to present the selected phonetic notation to the user as the speech recognition result.

On the other hand, if the score is equal to or smaller than the threshold value (NO in step S508), the flow advances to step S510 to notify the user that the speech recognition has failed (step S510).

With the comparison process of the score and threshold value in step S508, an input such as a user's utterance error, cough, or the like can be rejected.

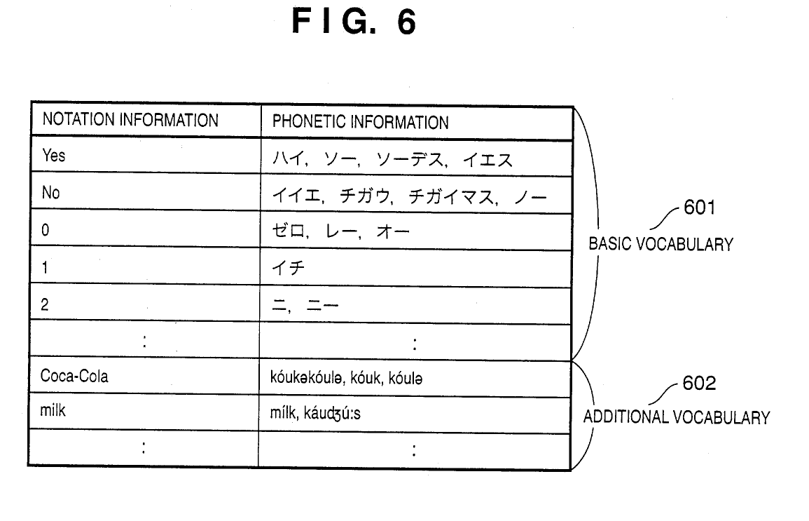

An example of the configuration of the recognition vocabulary database 111 will be described below using FIG. 6.

FIG. 6 shows an example of the configuration of the recognition vocabulary database according to the first embodiment of the present invention.

The recognition vocabulary database 111 has recognition vocabulary data each including notation information and phonetic information like in vocabulary information in external data. Especially, the recognition vocabulary database 111 manages recognition vocabulary data while categorizing them into a basic vocabulary 601 that the speech recognition apparatus 104 stores from the beginning, and additional vocabulary 602 added by the external data.

Words such as “yes” and “no”, numerals “zero” to “nine”, and the like, which may be used in every jobs are stored as the basic vocabulary in the recognition vocabulary database. In this manner, since the basic vocabulary need not be fetched as external data, the number of times of reading of external data, and the vocabulary data size contained in the external data can be reduced.

When the recognition vocabulary clear switch 102b has been pressed, the recognition vocabulary management unit 114 may clear both of the basic vocabulary 601 and additional vocabulary 602 or the additional vocabulary 602 alone.

As described above, according to the first embodiment, external data which expresses vocabulary information that the user is expected to utter is read, and a speech recognition process is done by combining the vocabulary information in the external data and the recognition vocabulary data in the recognition vocabulary database 111 prepared in advance in the apparatus.

In this manner, unwanted recognition words upon a speech recognition process can be reduced, and the speech recognition ratio can be improved. Since new recognition words are read from the external data, speech recognition other than recognition vocabulary data registered in the recognition vocabulary database 111 can be made.

<Second Embodiment>

Nowadays, in services such as a delivery service of beverages, that of a transport company, and the like in which a service person rounds a plurality of places, and makes a job at each place, a portable terminal such as a portable phone, PDA, or the like is used as a tool for that service management. For example, as one of delivery services of beverages, replenishment of vending machines is known. A delivery service person rounds respective vending machines and replenishes them with beverages. At this time, the types and numbers of replenished beverages must be recorded. It is convenient to input them via a voice. When recognition words used to recognize such speech inputs are managed by a portable terminal, the load on the portable terminal is often heavy.

The second embodiment will exemplify a case wherein the arrangement explained in the first embodiment will be applied to a portable terminal used in, e.g., a delivery service of beverages.

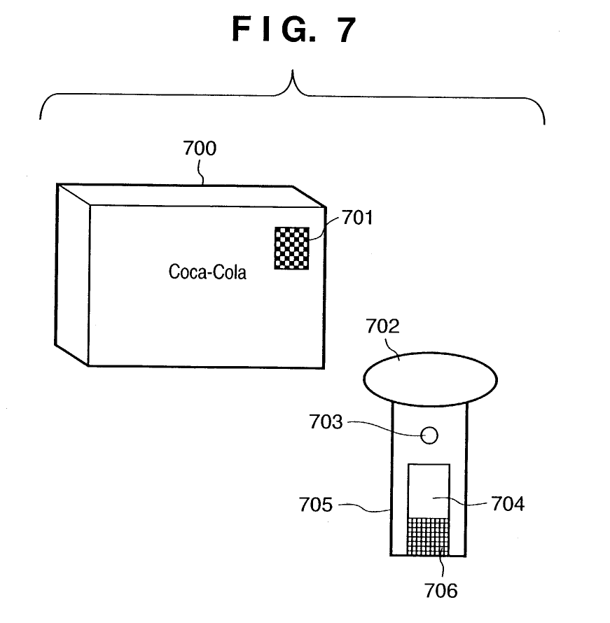

FIG. 7 shows the arrangement of a speech recognition apparatus according to the second embodiment of the present invention, and especially shows an example wherein recognition words to be used in speech recognition are added to a portable terminal.

A 2D barcode 701 which includes vocabulary information of a commodity name and manufacturer name is printed on a package 700 that contains commodities. A delivery service person reads the printed 2D barcode 701 using a 2D barcode reader 702 to fetch information into his or her portable terminal 705 when he or she takes that package 700 aboard a carrier. By repeating this operation, the commodity name and manufacturer name printed on each package 700 can be added to the portable terminal 705 as recognition words.

Using these recognition words, the delivery service person need only utter the name of commodities to be replenished (e.g., [three Coca-cola] “θri: kôuk” or the like) to a microphone 703 to input it to the portable terminal 705. A speech recognition result of this speech input is displayed on, e.g., a display 704. The speech recognition result can be edited using a ten-key pad 706 as needed.

Since the recognition words required in the delivery service of beverages are limited to the load of that day, a. recognition ratio drop can be avoided. Also, upon completion of the delivery service, since these recognition words need not be registered in the portable terminal 705, the storage resources of the portable terminal 705 can be effectively used.

Also, since a word such as [three] “θri:” or the like is stored as a basic word in the terminal, such items need not be loaded from the external data. Hence, the external data read operation can be simplified.

<Third Embodiment>

The third embodiment will exemplify a case wherein the arrangement explained in the first embodiment is applied to a portable game machine.

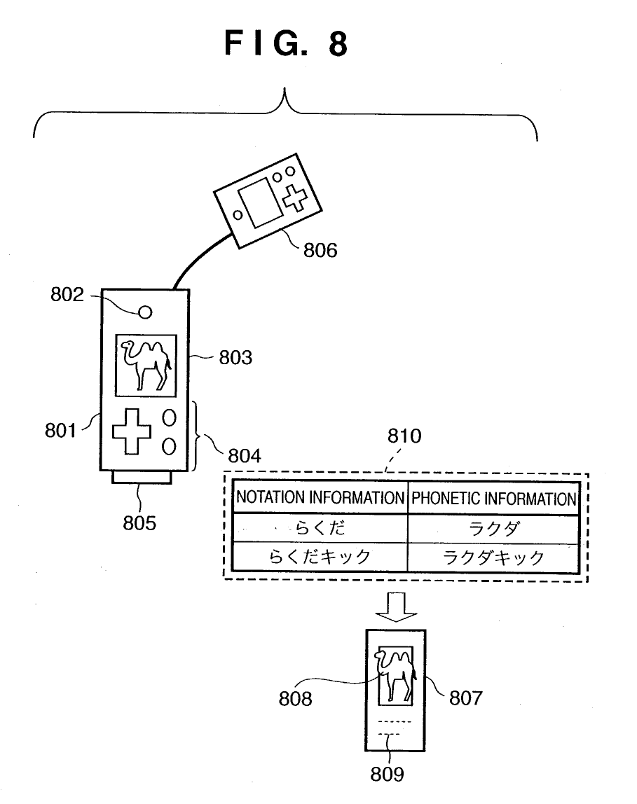

FIG. 8 shows the arrangement of a speech recognition apparatus according to the third embodiment of the present invention, and especially shows an example wherein recognition words to be used in speech recognition are registered in a portable game machine.

A portable game machine 801 incorporates a card scanner 805, and the user inserts a prescribed number of commercially available cards 807 into this card scanner 805 to play a game. Each card represents, e.g., a character which appears in the game, and can record the name of that character and game related information such as skills or the like required to play the game. Especially, the card records vocabulary information corresponding to that game related information. When this vocabulary information is input to the portable game machine, speech recognition of speech corresponding to that vocabulary information can be implemented.

In the third embodiment, embedding data 810 which represents this vocabulary information and is generated by a digital watermark technique is embedded in a character image 808 on each card 807 on which the character image 808 and its comment 809 are printed.

Note that the digital watermarking technique is used to embed imperceptible helpful data in an image or the like, and it can embed vocabulary information without impairing artistry of a card. Also, the portable game machine has a recognition function of data generated by this digital watermarking technique.

The user captures the contents of this card 807 into his or her portable game machine 801 by operating a controller 804. By repeating this operation, game related information required to play a game can be added as vocabulary information to the portable game machine 801.

In this manner, the user can select a desired character and skill using the controller 804 of the portable game machine 801, and can also select game related information by inputting corresponding speech via a microphone 802. A speech recognition result of this speech input is displayed on, e.g., a display 803, or a command corresponding to that speech recognition result is executed.

In this way, when a card that contains vocabulary information corresponding to new game related information is released and the user registers such information in the portable game machine 801 as needed, a speech input environment using new recognition words that cannot be expected initially can be provided to the user.

<Fourth Embodiment>

The fourth embodiment will exemplify a case wherein the arrangement explained in the first embodiment is applied to, e.g., a portable phone.

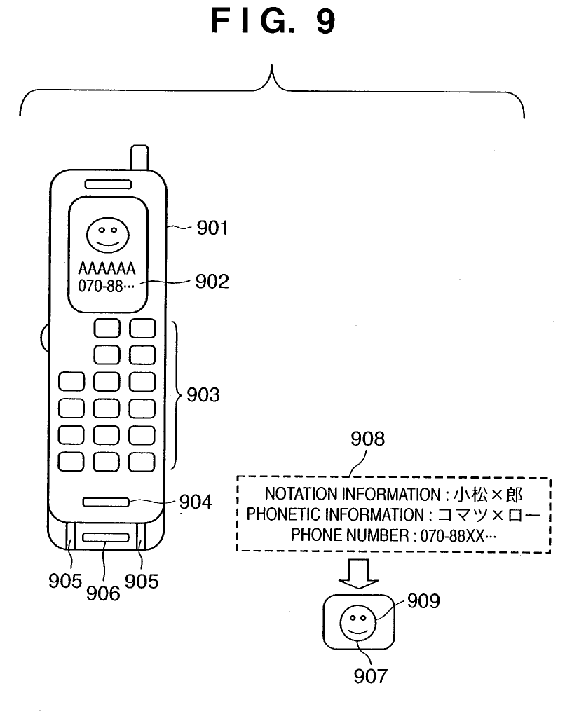

FIG. 9 shows the arrangement of a speech recognition apparatus according to the fourth embodiment of the present invention, and especially shows an example in which recognition words to be used in speech recognition are added to a portable phone.

A handy scanner 906 is built in a bottom portion of a portable phone 901, and can capture a photo sticker 907 that can be created in, e.g., a penny arcade or the like. On this photo sticker 907, vocabulary information which includes notation information and phonetic information of the name of an object, a phone number, and the like can be recorded using a digital watermarking technique when the sticker is created. When this photo sticker is captured by the portable phone 901, speech recognition of speech corresponding to the vocabulary information can be implemented.

In the fourth embodiment, embedding data 908 which represents this vocabulary information and is generated by a digital watermark technique is embedded in an object image (embedded with digital watermark of recognition vocabulary) 909 on the photo sticker 907. As in the third embodiment, the portable phone 901 has a recognition function of digital watermark data, needless to say.

The user who has got the photo sticker 907 captures this photo sticker 907 into the portable phone 901 via the scanner 906 by operating a console 903. Note that rollers 905 that allow an easy capture operation are arranged at the two ends of a read unit of the scanner 906.

In this manner, the phone number, and notation information and phonetic information of the name in the embedding data 908 in the captured object image 909 can be added to the portable phone 901.

The user inputs speech corresponding to the name of the object image 909 on the photo sticker 907 via a microphone 904 to dial the phone number of that object and to display the corresponding object image 909 on a display 902.

Note that application examples of the arrangement explained in the first embodiment are not limited to the second to fourth embodiments, and the present invention can be applied to other information devices such as a printer, scanner, digital camera, facsimile, copying machine, and the like, which allow operations via speech inputs.

The preferred embodiments of the present invention have been explained, and the present invention may be applied to either a system constituted by a plurality of devices, or an apparatus consisting of a single equipment.

Note that the present invention includes a case wherein the invention is achieved by directly or remotely supplying a software program (a program corresponding to the illustrated flow chart in the above embodiments) that implements the functions of the aforementioned embodiments to a system or apparatus, and reading out and executing the supplied program code by a computer of that system or apparatus. In this case, the form is not limited to a program as long as it has functions of the program.

Therefore, the program code itself installed in a computer to implement the functional process of the present invention using the computer implements the present invention. That is, the present invention include the computer program itself for implementing the functional process of the present invention.

In this case, the form of program is not particularly limited, and an object code, a program to be executed by an interpreter, script data to be supplied to an OS, and the like may be used as along as they have the program function.

As a recording medium for supplying the program, for example, a floppy (tradename) disk, hard disk, optical disk, magnetooptical disk, MO, CD-ROM, CD-R, CD-RW, magnetic tape, nonvolatile memory card, ROM, DVD (DVD-ROM, DVD-R) and the like may be used.

As another program supply method, the program may be supplied by establishing connection to a home page on the Internet using a browser on a client computer, and downloading the computer program itself of the present invention or a compressed file containing an automatic installation function from the home page onto a recording medium such as a hard disk or the like. Also, the program code that forms the program of the present invention may be segmented into a plurality of files, which may be downloaded from different home pages. That is, the present invention includes a WWW server which makes a plurality of users download a program file required to implement the functional process of the present invention by the computer.

Also, a storage medium such as a CD-ROM or the like, which stores the encrypted program of the present invention, may be delivered to the user, the user who has cleared a predetermined condition may be allowed to download key information that is used to decrypt the program from a home page via the Internet, and the encrypted program may be executed using that key information to be installed on a computer, thus implementing the present invention.

The functions of the aforementioned embodiments may be implemented not only by executing the readout program code by the computer but also by some or all of actual processing operations executed by an OS or the like running on the computer on the basis of an instruction of that program.

Furthermore, the functions of the aforementioned embodiments may be implemented by some or all of actual processes executed by a CPU or the like arranged in a function extension board or a function extension unit, which is inserted in or connected to the computer, after the program read out from the recording medium is written in a memory of the extension board or unit.

As many apparently widely different embodiments of the present invention can be made without departing from the spirit and scope thereof, it is to be understood that the invention is not limited to the specific embodiments thereof except as defined in the appended claims.

What is claimed is:

1. A speech recognition apparatus for recognizing input speech, comprising:
storage means for storing recognition vocabulary information for speech recognition;
input means for inputting speech data;
read means for reading external data including vocabulary information;
speech recognition means for making speech recognition of the speech data using the vocabulary information in the read external data, and the recognition vocabulary information; and
output means for outputting a speech recognition result of said speech recognition means.

2. The apparatus according to claim 1, wherein the vocabulary information in the read external data contains phonetic information of a word.

3. The apparatus according to claim 1, wherein the external data has a format that allows printing on a recording medium.

4. The apparatus according to claim 3, wherein the external data is a two-dimensional barcode.

5. The apparatus according to claim 3, wherein the external data is an image which contains the vocabulary information generated by a digital watermarking technique.

6. The apparatus according to claim 1, further comprising:
management means for managing the recognition vocabulary information; and
input means for inputting a processing instruction to said management means.

7. The apparatus according to claim 6, wherein said management means deletes at least some items of the recognition vocabulary information on the basis of an instruction input from said input means.

8. A speech recognition method for recognizing input speech, comprising:
an input step of inputting speech data;
a read step of reading external data including vocabulary information;
a speech recognition step of making speech recognition of the speech data using the vocabulary information in the read external data, and recognition vocabulary information stored in a recognition vocabulary database; and
an output step of outputting a speech recognition result of the speech recognition step.

9. The method according to claim 8, wherein the vocabulary information in the read external data contains phonetic information of a word.

10. The method according to claim 8, wherein the external data has a format that allows printing on a recording medium.

11. The method according to claim 10, wherein the external data is a two-dimensional barcode.

12. The method according to claim 10, wherein the external data is an image which contains the vocabulary information generated by a digital watermarking technique.

13. The method according to claim 8, further comprising:
a management step of managing the recognition vocabulary information; and
an input step of inputting a processing instruction to the management step.

14. The method according to claim 13, wherein the management step includes a step of deleting at least some items of the recognition vocabulary information on the basis of an instruction input from the input step.

15. A program for making a computer implement speech recognition for recognizing input speech, comprising:
a program code of an input step of inputting speech data;
a program code of a read step of reading external data including vocabulary information;
a program code of a speech recognition step of making speech recognition of the speech data using the vocabulary information in the read external data, and recognition vocabulary information stored in a recognition vocabulary database; and
a program code of an output step of outputting a speech recognition result of the speech recognition step.
